(19) United States
(12) Patent Application Publication
(10) Pub. No.: US 2017/0087455 A1
(43) Pub. Date: Mar. 30, 2017

(54) FILTERING CONTROLLER INPUT MODE

(71) Applicant: SONY COMPUTER ENTERTAINMENT INC., Tokyo (JP)

(72) Inventor: Glenn Black, San Mateo, CA (US)

(21) Appl. No.: 14/868,242

(22) Filed: Sep. 28, 2015

(51) Int. Cl. A63F 13/235; A63F 13/44; A63F 13/212; A63F 13/215; H04W 4/00; A63F 13/825; A63F 13/60; A63F 13/218; G06F 3/01; G06F 3/00; A63F 13/211; A63F 13/213

(52) U.S. Cl. CPC A63F 13/235; A63F 13/211; A63F 13/44; A63F 13/212; A63F 13/215; A63F 13/213; A63F 13/825; A63F 13/60; A63F 13/218; G06F 3/011; G06F 3/005; H04W 4/008; H04W 84/12

(57) ABSTRACT

A user can interface with a computer system to interact with a computer program using an input device. The device includes one or more tracking devices and an input mode control. The one or more tracking devices are configured to communicate information relating to a position, orientation, or motion of one or more controllers to the computer system. The input mode control is configured to communicate an input mode signal to the computer system during interaction with the computer program. The input mode signal is configured to cause the computer program to interpret the information relating to the position, orientation or motion of the one or more controllers according to a particular input mode of a plurality of different input modes.

### FIELD OF THE DISCLSOURE

Aspects of the present disclosure are related to methods and systems for interfacing a controller with a computer gaming system. Specifically, aspects of the present disclosure are related to methods and systems for interfacing a controller with a computer program executing at a base computing device using gesture inputs.

### BACKGROUND

The video game industry has seen many changes over the years. As computing power has expanded, developers of video games have likewise created game software that takes advantage of these increases in computing power. To this end, video game developers have been coding games that incorporate sophisticated operations and mathematics to product a very realistic game experience.

Example gaming platforms include the Sony Playstation ®, Sony Playstation2 ® (PS2), Sony Playstation 3 ® (PS3), and Sony Playstation 4 ® (PS4), and each of these platforms is sold in the form of a game console. As is well known, a game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with other users over the Internet. As game complexity continues to intrigue players, game and hardware manufacturers have continued to innovate to enable additional interactivity and computer programs.

A growing trend in the computer gaming industry is to develop games that increase the interaction between user and the gaming system. One way of accomplishing a richer interactive experience is to use wireless game controllers whose movement is tracked by the gaming system in order to track the player's movements and use these movements as inputs for the game. Generally speaking, gesture input refers to having an electronic device such as a computing system, video game console, smart appliance, etc., react to some recognized pattern of movement captured by a video camera or other device that tracks movement of an object.

However, gesture input often requires extensive processing power and time to correctly distinguish between regular movements made by a user and input gestures made by a user. Due to the need for complicated error rejection algorithms, which add input delay and require dedicated processing power, the incorporation of gesture input features into real-time gaming has been troublesome.

It is within this context that embodiments of the present invention arise.

### BRIEF DESCRIPTION OF THE DRAWINGS

The teachings of the present disclosure can be readily understood by considering the following detailed description in conjunction with the accompanying drawings, in which:

FIG. 1 depicts a cross section of an embodiment of a controller capable of adjusting the input channel of a computer system in accordance with aspects of the present disclosure.

FIG. 2 is a block diagram of the elements of a computer gaming system interfaced with a controller capable of adjusting the input channel of the computer gaming system, in accordance with aspects of the present disclosure.

FIG. 3 is a schematic diagram of a gaming environment according to embodiments of the present disclosure.

FIG. 4 depicts a component device capable of interfacing with a computer gaming system according to embodiments of the present disclosure.

FIG. 5 is a flow diagram illustrating input channel filtering in accordance with aspects of the present disclosure.

### INTRODUCTION

Aspects of the present disclosure provide methods and devices for interfacing a controller with a computer program executing at a computer system. A component device or devices interfaced with the computer system allow a user to command the computer program via analog, digital, touch, motion, and vocal inputs, in additional to various other types of input. Motion control input may be selectively interpreted according to different input modes, wherein each input mode has its own set of interpretable motions or gestures that correspond to a specific control input. A user may adjust the motion control input mode to enable gesture control of a computer system in order to provide multiple types of motion control input that can effectively be utilized by the user and the computer system. A user may adjust the motion control input mode in a multitude of ways, including the manipulation of a hardware element, by providing a vocal or auditory command, by performing a specified action in conjunction with an interfaced component device, etc.

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### DETAILED DESCRIPTION

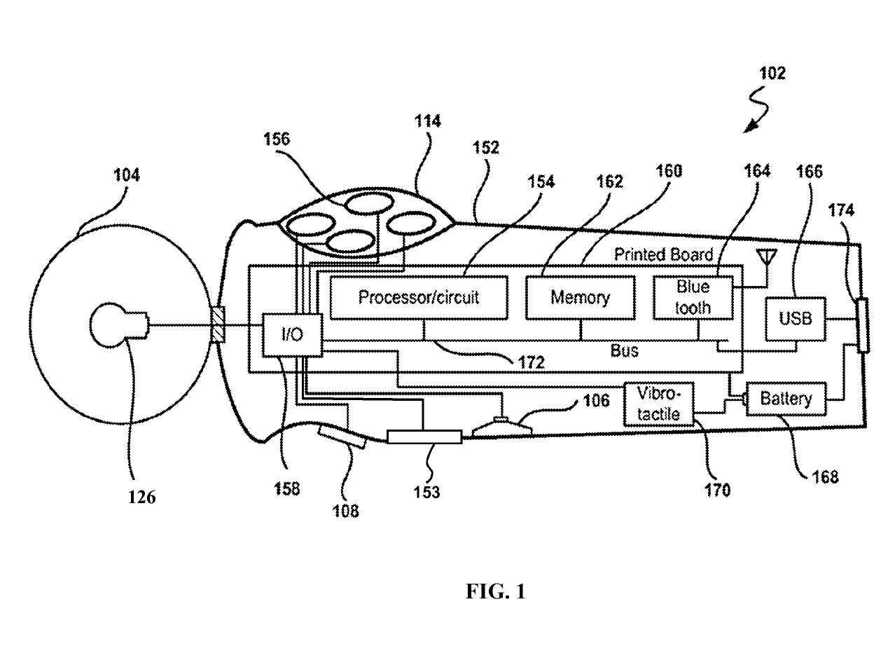

FIG. 1 depicts a cross section of an embodiment of a game controller capable of adjusting the input channel of a computer system. By way of example, and not by way of limitation, the computer system may be a computer gaming system. The components of the controller 102 are shown in this cross section, and although controllers defined within the spirit and scope of the claims may have more or less components, these example components show example electronics, hardware, firmware, and housing structure to define an operable example. These example components, however, should not limit the claimed invention, as more or fewer components are possible. With this in mind, the controller includes a body 152 (that is hand held) and an optically diffusive spherical section 104, also referred to herein as a ball. Body 152 is configured to provide a handle to operate controller 102 with a single hand. A user's second hand may, of course, be used to hold or select buttons on body 152.

A user holding controller 102 can provide input to the computer system by pressing buttons, such as top buttons 156 on a buttons pad 114and bottom button 108, and by moving the controller within a three-dimensional space, wherein the movement of the controller is tracked by the computer system. Top buttons 156 can be configured for action buttons or as a directional pad. Bottom button 108 can be used in application such as firing, picking up an object, turning on or off a flashlight, etc. A touch interface 153, e.g., a touch pad, may also be disposed on one side of body 152, and may provide an area for receiving directionality control in response to interfacing by a finger of a user. In various embodiments of the present disclosure, an existing hardware element, e.g., any of the top buttons 152, bottom button 108, or the touch interface 153 may be alternatively utilized or re-mapped as an input mode control capable of triggering a change in interpretation of the motion control input from one input mode to another, e.g., from a standard input mode to a gesture control input mode. In other embodiments, existing controller technology may be re-engineered, or a new controller or component device may be established to provide a hardware input mode control. In still other embodiments of the present disclosure, a hardware element is not needed to activate the input mode control.

Controller 102 may be configured to operate wirelessly, which facilitates freedom of controller movement in order to interact with the computer system. Wireless communication can be achieved in multiple ways, such as via Bluetooth ® wireless link, WiFi, infrared link, or visually by capturing images of the device by a camera attached to the computer system.

Spherical section 104 can be illuminated different ways by a light emitting device 126, such as with different colors, different brightness, and in intermittent fashion. The visual cues generated by spherical section 104 can be used to provide visual feedback to the user holding the controller, and may be used to provide feedback to other users interacting with the user holding the controller. The visual cues can also provide visual input to the computer system via an image capture device that takes images of the area around controller 102.

Inside body 152, printed circuit board 160 holds processor 154, Input/Output (I/O) module 158, memory 162, WiFi module 178, and Bluetooth module 164, interconnected by bus 172. A Universal Serial Bus (USB) module 166 also provides interactivity with the base computing device, or other devices connected to USB port 174. The USB port can also be used to charge the rechargeable battery 168. A speaker 106 may generate audio signals, and vibrotactile feedback is provided by vibrotactile module 170.

One or more components of the controller 102 may be configured to trigger and/or generate an input mode control signal, which may be transmitted to a computer system. The input mode signal may be transmitted from the controller to a computer system in any of a number of different ways. For example, the input mode control signal may be transmitted wirelessly, e.g., via the BlueTooth module 164 or the WiFi module 178. The computer system may include suitable hardware and/or software for receiving and interpreting such wireless signals. Alternatively, the controller 102 may transmit the signal optically via the light emitting device 126. An optical sensor or camera may be coupled to the computer system, which may include suitable hardware and/or software for digitizing and interpreting such an optical signal. By way of example, and not by way of implementation, such an optical signal may be implemented, e.g., by pulsing the light emitting device in a coded manner or by changing a color of light emitted by the light source.

In still other implementations, the input mode control signal may be transmitted via the USB module 166 and the USB port 174, e.g., though a USB cable connected to the computer system or via a some other wired or wireless communication module coupled to the USB port and to the computer system.

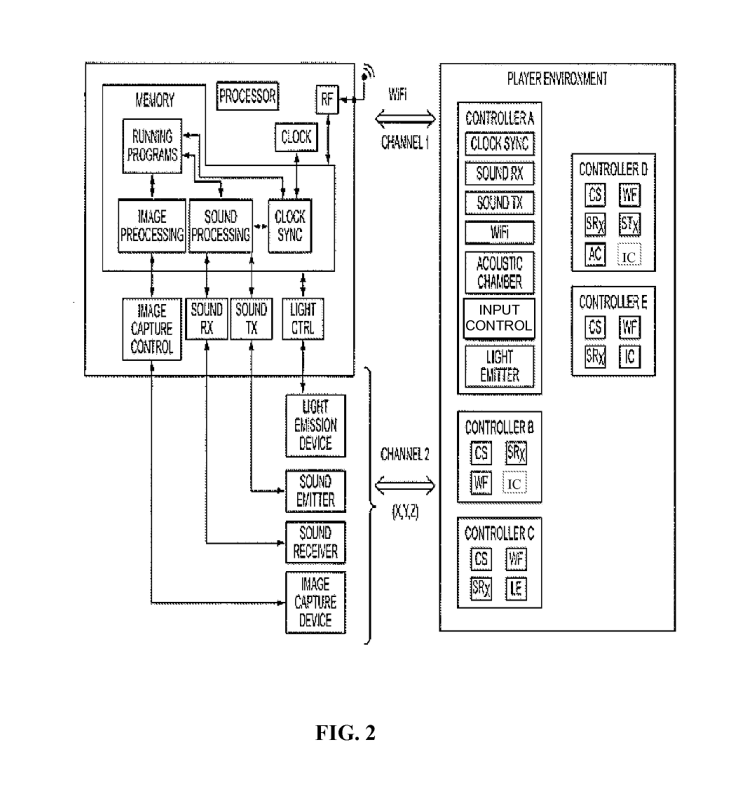

FIG. 2 is a block diagram of the elements of a computer gaming system interfaced with the controller embodied in FIG. 1. The computer gaming system and its components are located on the left side of FIG. 2, and the player environment is shown on the right side. The computer gaming system includes a processor, a memory area, a clock, and communication interfaces. The communication interfaces include a radio-frequency (RF) interface for wireless communications to one or more controllers, such as communications using the WiFi™ protocol. Other communication methods include image capturing, sound transmission and reception (ultrasonic in this embodiment), and light emitters.

The different communication devices connected to the computer gaming system connect to the respective controllers interfaced with the computing system. The memory area includes running programs, an image processing area, a sound processing area, and a clock synchronization area. Running programs include a gaming program, image processing program, sound processing program, clock synchronization program, etc. These programs use the corresponding areas of memory, such as the image processing and area containing image data, the sound processing area containing ultrasound communications data, and the clock synchronization area used for the synchronization with remote devices.

Several embodiments for controller configuration are shown in the player environment area. Controller A represents a “fully loaded” controller with many of the features previously described with respect to FIG. 1. Controller A includes a Clock Synchronization (CS) module used for clock synchronization with the computer gaming system; a Sound Receiver (SRx) for receiving ultrasonic data; a Sound Transmitter (SRx) for sending ultrasonic data; a WiFi (WF) module for WiFi communications with the computer gaming system; an Acoustic Chamber (AC) for conducting sound to and from the front and/or sides of the controller; an Input Control (IC), capable of adjusting the motion control input channel for alternative motion control inputs received from the controller; and a Light Emitter (LE) in the infrared or visible spectrum for easier image recognition from the image processing module at the computer gaming system.

Additionally, controller A may include a spherical section (not shown), to improve tracking of the controller A through image recognition by a remote capture device. The light emitter LE may be contained in an optically diffusive spherical section. The different components in Controller A can be implemented as separate devices or modules inside Controller A. In another embodiment, the different components in Controller A are grouped into a smaller number of integrated components enabling a more compact implementation. The various controllers can also include one or more USB plugs, to enable charging of the controllers when connected to the game station or a computer.

According to the intended use of a given controller, simpler configurations can be used with fewer features than those described for Controller A. Some embodiments of simpler devices are shown with respect to Controllers B, C, D, and E utilizing a subset of features from those described for Controller A. A person skilled in the art will readily appreciate that similar configurations are possible within the spirit of the invention by adding or subtracting components, as long as the principles of the invention are maintained.

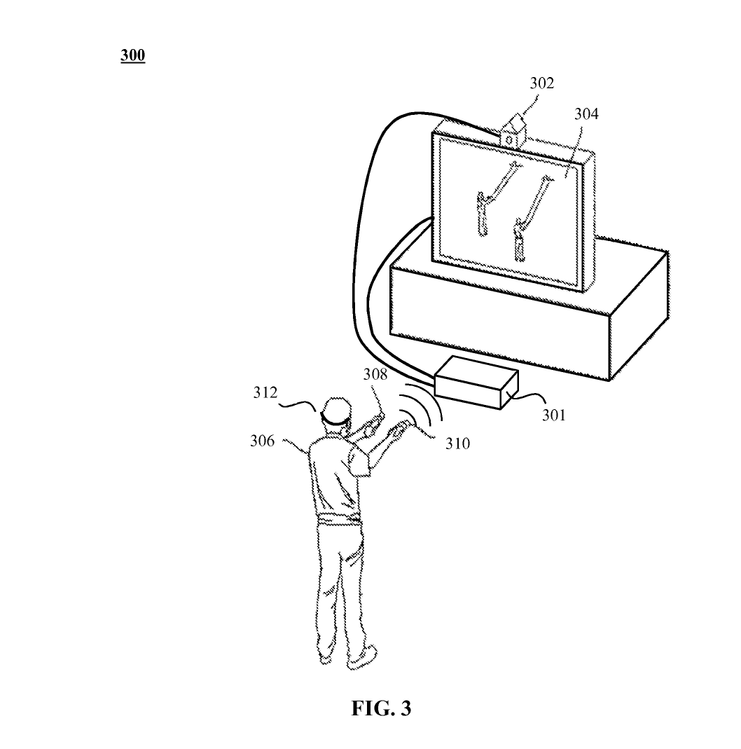

FIG. 3 is a schematic diagram of a potential gaming environment which describes multiple embodiments of the present disclosure. The gaming environment 300 may include a computer gaming system 301 that may be coupled, e.g., through cables or wirelessly to an image capture device 302 and a display 304. A user 306 may interact with the computer gaming system 301 via one or more controllers 308 and 310, and/or a wearable device 312, which may be wirelessly coupled to the computer gaming system. The computer gaming system 301 may include, for example, a server, an embedded system, mobile phone, personal computer, laptop computer, tablet computer, portable game device, workstation, game console, wearable device such as a smart watch, virtual reality (VR) devices and/or augmented reality (AR) devices, such as “Google glasses” or Microsoft Hololens, and the like. Any of these example devices, alone or in combination with any of the above-mentioned component devices, could be programmed, re-designed, or purposefully built to be compatible with aspects of the present disclosure.

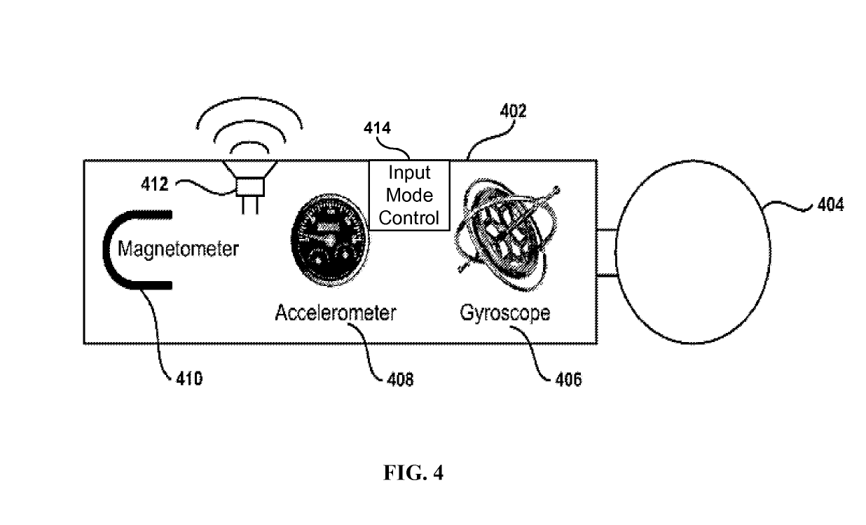

In one example embodiment of the present disclosure, the user 306 may interact with the computer system 301 via a controller 308, the display 304, and the image capture device 302. The image capture device 302 may capture images of the user or the controller and the computer system 301 may analyze these images to track the motion of the controller 308 or the user 306 throughout the three-dimensional space of the gaming environment 300. The computer system 301 may interpret the tracked motion of the user or the controller as manipulated by the user as control input for the computer gaming system, e.g., for controlling a virtual object or character in a game. The computer system 301 may also analyze and interpret images obtained by the image capture device 302 track position and/or orientation data of the controller 308 or the user 306 for interpretation by the computer gaming system 301 as control input information. The position, motion, and/or orientation data of the controller itself may also be transmitted from the controller 308 to the computer gaming system 301 via the utilization of various components of the controller as discussed with respect to FIG. 4, below.

Position data may include, for example, the location of the controller in a three-dimensional space (including x, y, and z-coordinates) as determined from an initial calibration point of the controller, the location of the controller with respect to the image tracking device 302 or computer gaming system 301, or even the apparent size of an optical diffuser included on controller 308 with respect to the controller 308′s distance from the image tracking device 302. Motion data may include, for example, data related to the velocity, acceleration, angular velocity, and/or angular acceleration of the controller, in addition to data related to the displacement and/or speed of the controller with respect to the controller's position in three dimensional space. Orientation data may include, for example, data related to the angular movement of the controller, including the roll, pitch, or yaw of the controller.

Position, motion, and/or orientation data of the controller may be used to provide control input to the computer gaming system, either as a supplement to the image tracking data or as an alternative means of providing control input. The computer gaming system 301 may be responsible for processing all such position, motion, and/or orientation data transmitted from the controller 308, although alternative embodiments (e.g., a computer gaming system of the type shown in FIG. 2) provide that a controller may be able to provide some processing of the position, motion, and/or orientation data before transmitting it to the computer gaming device.

The computer system 301 often uses extensive processing power and time to correctly distinguish between different input modes, e.g., between regular input control movements made by a user to control a virtual object and movements, e.g., gestures, which the user desires to be interpreted by the computer gaming system as input commands. It is standard for a computer gaming system in such an example arrangement to utilize complicated error rejection algorithms that may discount smaller gestures made by a user. Such algorithms additionally add input delay and require dedicated processing power. Accordingly, in order to provide input to the computer gaming system, a user often has to make broad, overt movements with the controller in order for the system to register a movement as a desired control input. For this and other reasons, the incorporation of gesture input features into real-time gaming has been troublesome.

According to an aspect of the present disclosure, the controller 308 may include an input mode control. The input mode control may be, implemented for example, by a hardware component. By way of example, and not by way of limitation, such a hardware element may be in the form of a digital or analog button or switch. However, as described with respect to

FIG. 1 and additional embodiments described herein, the input mode control is not limited to a hardware element. In the non-limiting example depicted in FIG. 3, a user 306 may press or activate the input mode control built into controller 308. Activating the input mode control changes the motion control input mode of the computer system, e.g., from a standard motion control input mode to one or more gesture input modes. The gesture input modes allow for the computer system 301 to interpret smaller, less-overt, or even delicate or ephemeral gestures made by the user 306 with the controller 308 as input commands. The input mode control allows a user to provide control inputs to the computer gaming system with potentially smaller, more precise movements without the need for error rejection algorithms. This reduces the amount of processing power needed by the computer system to determine the input mode and also reduces the input lag experienced by the user. The gestures and gesture mapping utilized in the disclosed gesture input mode may be fully programmable.

In alternative implementations, the activation of the input mode control may cause the computer gaming system to display a user interface (UI) that is specific to the gesture input mode. A gesture mode UI may provide specific input options the user is capable of making using the gesture input mode, for example: selecting a portion of a pie menu by swiping the controller to the left, right, up, or down; navigating a menu or screen using directional arrows by moving the controller left, right, up, or down; turning “pages” in a digital “novel” by flicking the controller left or right; drawing a line for password input; navigating a map or puzzle display in three-dimensions by moving the controller left, right, up, or down to move to different parts of the display and moving the controller forwards or backwards to zoom in and/or out. Additionally, the gesture input mode may have specific overlays when activated, for example: application specific overlays; level or game context specific overlays (e.g., a user's avatar is holding a specific tool or weapon, whether or not a user is riding in or driving a specific vehicle); or activating an inventory management overlay. Such overlays or UI's may alternatively be presented to a user only when the input mode control is activated during a “cut scene” of computer game or program. In alternative embodiments, no UI is presented to the user via a display upon the activation of the input mode control, but instead the gesture input mode runs and operates in the background without alerting a player that the gesture input mode has been activated.

Alternative aspects of the present disclosure provide that the gesture input mode may be used to trigger control of television or display functions, remote control or video playback functions, or web browsing functions. Additionally, other aspects may provide for activating the gesture input mode to allow for one-to-one mapping of motion of the controller 308 or controllers 308, 310 to corresponding motion of a user's avatar character.

Various control schemes for the gesture input mode may be utilized, in accordance with the example provided or other aspects of the present disclosure. The example above provided that a user actives the gesture input mode via the push of a button on a controller. Accordingly, in this example, the gesture input mode would be deactivated upon a subsequent press of the button. In alternative embodiments, the gesture input mode may remain active only when a user continuously activates the hardware element, for example, by continuing to a hold down an input mode control button. In such an embodiment, the gesture input mode may be deactivated upon the release of the input mode control button, and the computer gaming system would revert to the standard motion control input channel and mode. In an alternative embodiment, the gesture input mode may be activated when the input mode control button is held down, but the input command gesture made by the user may be executed only upon the release of the input mode control button. In yet another embodiment of the present invention, the gesture input mode may be activated by the user, and automatically exited when the computer gaming system recognizes a gesture input command.

In alternative embodiments, the input mode control may be a digital button that must be pressed to activate the gesture control mode, a touch-sensitive region of a component device, or an analog button, wherein an input past a certain threshold provides a standard action or directional control input, but an input below that threshold activates the gesture input mode, or vice versa. An alternative embodiment provides that a hardware element, for example, a digital button, must be manipulated or held for a threshold period of time in order to activate the gesture input mode. The threshold time period for activating a gesture input mode with a hardware element may fall within the range of 150-200 milliseconds, but may be either more or less, as determined by the application and user settings. In an alternative embodiment, the input mode control may be a pressure sensitive button that provides one or more gesture input modes in response to alternative amounts of pressure applied by the user.

In another alternative embodiment, the input mode control may be a two-state button. A two-state input mode control button may have an action or directional control mapped as a standard input function, and as long as no gesture is made while the button is pressed, the input is received by a computer gaming system as the standard action or control input. However, if the controller is being moved by the user or a gesture is made while the two-state input control button is activated, the gesture input mode is activated. In such an embodiment, the movement associated with the gesture input mode activation may be either two-dimensional or three-dimensional movement.

In accordance with certain aspects of the present disclosure, the gesture input mode may not be available to the user at all times. Instead, the gesture input mode may only be available to the user at certain times or during certain events over the course of execution of a computer program, or may alternatively be selectively or automatically disabled during certain portions of computer program execution. Examples of the limited availability of a gesture input mode include disabling the gesture input mode during a cut scene, disabling gesture input mode in a plot-driven computer program to reflect the limited capabilities of a playable character, etc. In alternative embodiments, the computer gaming system may prompt a user to enter gesture input mode via a cue or prompt. Examples of such prompts may include visual, auditory, or haptic prompts delivered to the user via the display or accompanying audio delivery system, the computer gaming system itself, or even the component devices themselves. Specific examples of prompts include, but are not limited to, a prompt displayed on the screen, a light or flash of light emitted by the computer gaming system or its interfaced component devices, a haptic prompt in an interfaced component device, or an auditory prompt emitted through the interfaced audio system or delivered to and output by an interfaced component device. Such prompts may be contextual to the program being utilized by the user.

According to certain embodiments of the present disclosure, activating a gesture input mode may require user interaction with more than one component device. In an example embodiment, a computer gaming system may optionally provide a user 306 with multiple controllers 308 and 310. In this example, controller 308 may have a hardware element for activating a gesture control mode. Once the user activates the hardware element, the gesture control mode is activated, however, the computer gaming system may then only interpret gestures made with controller 310. In an alternative embodiment, the hardware element for activating the gesture control mode may be located on a wearable component device, for example, a headset or head-mounted display 312. In such an example, the user may utilize a single controller 308 and a wearable component device, and manipulate the hardware element on the component to activate the gesture input mode, subsequently providing gesture inputs with the controller.

In alternative embodiments, the input mode control may not be a hardware component. Instead, the input mode control may be a specific motion made by the user with a controller or controllers, or component device or devices, and recognized by the computer gaming system and visual tracking component device as the input mode control. In alternative embodiments of the present disclosure, the computer gaming system or program may utilize the context of the game or program to determine whether or not a user desires to activate a gesture input mode or has simply made a standard motion control input command; in contexts where gesture recognition is more heavily weighted by the system or program, the system or program may activate a gesture input mode based on less stringent activation requirements (e.g., a not-yet-complete motion control command, a not-yet complete verbal command, etc.) In certain embodiments, the position of the component devices relative to the user may be utilized by the computer gaming system in determining whether to activate gesture input mode. In such embodiments, the computer gaming system may establish regions, relative to the user, in which the gesture input mode can be activated. Examples of such regions include, but are not limited to, Da Vinci quadrants, selected volume of spaces surrounding the user, or various zones within the motion tracking component device's range. In alternative embodiments, various zones may be utilized by a motion tracking system to map different controllers or component devices, or even to map body parts of a user where the user is providing control input to the computer gaming system without a component device (e.g., when utilizing motion tracking of a user's body as a control input).

In accordance with certain aspects of the present disclosure, the input mode control may also be a user movement or input interpreted by a wearable component device as the input mode control activation command For example, as a headset or head-mounted display may be programmed or prompted by a computer gaming system to interpret a certain eye movement, jaw clench, head tilt, or vocal or other auditory (such as a snap of the fingers or clap of the hands) command as the input mode control. In additional alternative embodiments, a user may act as a controller with no additional interaction with an interfaced component device outside a motion tracking system (e.g., when utilizing motion tracking of a user's body as a control input). Accordingly, a user may provide a input mode control to the computer gaming system via an action or command. For example, a user utilizing a motion tracking system may make eye contact with the motion tracking system and give either a verbal or other auditory command (such as a snap of the fingers or clap of the hands) to initiate gesture input mode, revert from gesture input mode to standard input mode, or otherwise change the input mode from one mode to a different mode. In another example, a user utilizing a motion tracking system may perform a certain action or motion which acts as an input command to the computer gaming system to change the input mode from standard motion tracking input to a gesture input mode, thereby activating the input mode control.

It is important to note that the features of the above-described embodiments may be interchangeable, resulting in example combinations including, but not limited to, user/controller, user/two controllers, user/controller/component device, user/component device, user/two controllers/component device, each without or without an interfaced motion tracking device, as well as the combination of user/motion tracking device. Additionally, each of the previously mentioned combinations may or may not have a hardware element capable of activating a gesture input mode; in embodiments with no hardware element, the gesture input control may be activated, for example, by a user motion or by vocal or auditory command interpreted by the computer gaming system as an activation command, potentially in combination with one or more component devices. It is also important to note that the component devices that may be utilized in accordance with the disclosed method include any device capable of interfacing with a computer gaming system and providing gesture input commands, including but not limited to gaming controllers, mobile phones, tablets, wearable device such as a smart watch, virtual reality (VR) devices and/or augmented reality (AR) devices, such as “Google glasses” or Microsoft Hololens, and the like.

FIG. 4 depicts an example of a potential controller device capable of interfacing with a computer gaming system in accordance with aspects of the present disclosure. Specifically, FIG. 4 depicts a controller 402, which includes a light source within an optical diffuser 404, e.g., an LED within a hollow translucent ball to facilitate movement tracking by image analysis and one or more additional sensors for improving movement tracking, according to an aspect of the present disclosure. Different implementations may include different combinations of sensors, such as magnetometers, accelerometers, gyroscopes, etc. An accelerometer is a device for measuring acceleration and gravity induced reaction forces. Single and multiple axis models are available to detect magnitude and direction of the acceleration in different directions. The accelerometer is used to sense inclination, vibration, and shock. In one embodiment, three accelerometers may be used to provide the direction of gravity, which gives an absolute reference for two orientation angles (world-space pitch and world-space roll). Controllers can experience accelerations exceeding 5 G, therefore accelerometers capable of withstanding and measuring forces exceeding 5 G may be used inside controller 402.

A magnetometer measures the strength and direction of the magnetic field in the vicinity of the controller. In one embodiment' three magnetometers 410 are used within the controller, ensuring an absolute reference for the world-space yaw angle. The magnetometer may be designed to span the earth magnetic field, which is approximately ±80 microtesla. Magnetometers can provide a yaw measurement that is monotonic with actual yaw of the controller 402. The Earth's magnetic field may be warped due to metal in the environment, which causes a warp in the yaw measurement. If necessary, this warp can be calibrated using information from other devices, e.g., gyros (see below) or a camera. In one embodiment, inertial sensor 408 may be used together with magnetometer 410 to obtain the inclination and azimuth of the controller.

By way of example, and not by way of limitation, the inertial sensor may be an accelerometer or a gyroscope. A gyroscope is a device for measuring or maintaining orientation, based on the principles of angular momentum. Gyroscopes include both mechanical gyroscopes and optical gyroscopes. A mechanical gyroscope operates on the principle of the conservation of angular momentum of a spinning mass. The sensitivity of an optical gyroscope to rotation arises from the invariance of the speed of light for all inertial frames of reference. An optical gyroscope, e.g., a ring laser gyroscope or fiber optic gyroscope, operates on the principle of the Sagnac effect, which shifts the nulls of an internal standing wave pattern due to two counter-propagating beams, e.g., in a coil of fiber, in response to angular rotation. Interference between the counter-propagating beams, observed externally, reflects shifts in that standing wave pattern, and thus rotation.

In one embodiment, three gyroscopes provide information about movement across the respective axis (x, y and z) based on inertial sensing. The gyroscopes help in detecting fast rotations. However, the gyroscopes can drift overtime without the existence of an absolute reference. This requires, resetting the gyroscopes periodically, which can be done using other available information, such as visual tracking of ball 404, accelerometer, magnetometer, etc. The desired spin rate of a mechanical gyroscope may depend on the maximum expected rotation rate for the controller 402. By way of example, and not by way of limitation, the rate of gyroscope rotation may be twice as large as the largest expected rate of rotation of the controller 402. For example, if a hand-held device can rotate faster than 500 degrees/sec, a gyroscope with a spec of more than 1000 degrees/sec would be recommended, but smaller values are also possible.

The information from the different sources can be combined for improved location and orientation detection. For example, if the lighted diffuser 404 disappears from a camera's field of view, the accelerometer's orientation sensing can be used to detect that the controller is facing away from the camera. In some implementations the controller 402 may include a speaker 412 to provide audio feedback to the player. The controller can produce an audible sound, e.g., a “beep”, when the ball is not visible, prompting the player to orientate the controller in the right direction or to come back into the camera's field of view.

According to an aspect of the present disclosure, the controller 402 may include an input mode control 414. The gesture input control may be, implemented for example, by a hardware component. By way of example, and not by way of limitation, such a hardware element may be in the form of a digital or analog button or switch, touch pad, joystick or other device configured to generate or trigger generation of an input mode signal that causes a computer system to change from interpreting controller input according one input mode to interpreting the controller input according to a different input mode. By way of example the signal may cause the computer system to change from a standard input mode to a gesture input mode, to revert from a gesture input mode to a standard input mode, or otherwise change the input mode from one mode to a different mode.

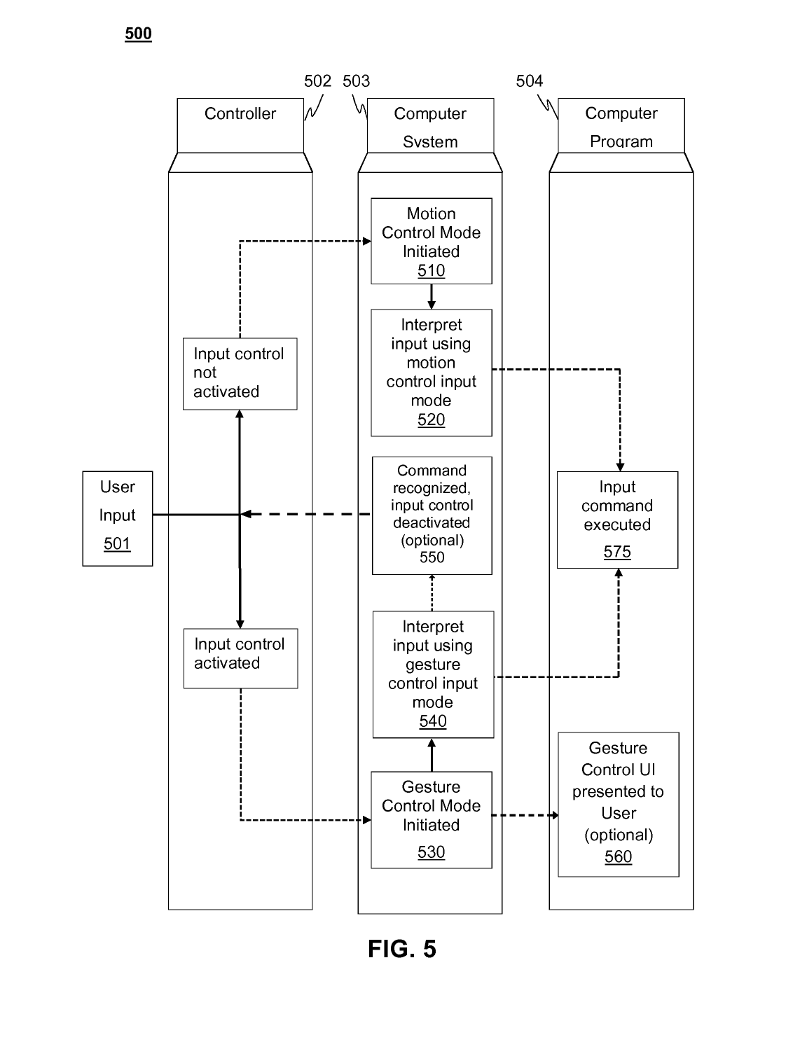

The input mode signal may be transmitted from the controller to a computer system in any of a number of different ways. For example, the controller 402, may transmit the signal acoustically via the speaker 412 and a microphone coupled to the computer system. The computer system may include suitable hardware and/or software for digitizing and interpreting such an acoustic signal. Alternatively, the controller 402 may transmit the signal optically via the light source in the diffuser 404. An optical sensor or camera may be coupled to the computer system, which may include suitable hardware and/or software for digitizing and interpreting such an optical signal. By way of example, and not by way of implementation, such an optical signal may be implemented, e.g., by pulsing the light source in a coded manner or by changing a color of light emitted by the light source. FIG. 5 is a flow diagram illustrating input channel filtering in accordance with aspects of the present disclosure. Such input channel filtering may be implemented as part of one or more programs running on a computer system, e.g., a computer gaming system of the type shown in FIG. 2. In an example embodiment of the present disclosure 500, a user input 501 is provided to a computer gaming system 503 executing a computer program 504 via an interfaced component device 502, e.g., a controller or visual tracking system. A user may utilize control inputs as command inputs for the computer program 504. The control inputs received by the computer system may be generated via the user's manipulation of either a component device or the user's own body in three-dimensional space. By way of example, and not by way of limitation, input data may be delivered to the computer system 503by utilizing a motion tracking device interfaced with the computer system 503 capable of capturing and interpreting the motion of a controller or a user, or by the controller 502′s transmission of data regarding its position, orientation, and/or motion to the computer system 503. For example, if a gesture control input has not been activated, the computer system may utilize control inputs as motion control inputs using a default motion control input mode 510, and such inputs may be processed by the computer gaming system using standard motion control input mode 520 analysis and processing. Inputs from the controller 502 may then be executed by the computer program 504 to either advance or facilitate gameplay, as shown at 575.

Alternatively, a user may activate a gesture input control when the user either desires to utilize the gesture input mode, or is prompted by the computer gaming system to utilize a gesture input in accordance with the embodiments disclosed with respect to FIG. 3. The gesture input control may be activated by, for example, manipulation of a hardware element, a verbal or auditory command, or a certain motion or action performed by the user (either with or without the utilization of additional component devices) that the computer system recognizes as the gesture input control activation command. Once the gesture input control has been activated, the computer system will interpret motion control inputs using a gesture input channel, as indicated at 530, and the computer system may then process such input according to a gesture input mode 540. The activation of the gesture control mode may also cause the computer program 504 to display a gesture control user interface to the user 560. An input command interpreted by the gesture input mode will be executed by the computer program 504 to either advance or facilitate gameplay, as shown at 575.

In certain embodiments, the gesture input mode may be deactivated after a gesture input command is received and recognized by the system, as indicated at 550, and the computer gaming system 503 may revert back to the default motion control input channel and motion control input mode once a gesture input command has been recognized, and, if the gesture input command is available to the user at that time, executed by the computer program 504. In alternative embodiments, the gesture input mode remains activated until a user deactivates the gesture input control, and a user may continue to input gesture commands until the user deactivates the gesture input control.

Once the gesture input control has been deactivated, the computer gaming system will revert from a gesture input channel to the default motion control input channel 510, and further motion control input will be processed by the computer gaming system using standard motion control input mode 520 analysis and processing until the input control is activated.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An input device for interfacing with a computer system to interact with a computer program, comprising:
one or more tracking devices configured to communicate information relating to a position, orientation, or motion of one or more controllers to the computer system; and
an input mode control configured to communicate an input mode signal to the computer system during interaction with the computer program, wherein the input mode signal is configured to cause the computer program to interpret the information relating to the position, orientation or motion of the one or more controllers according to a particular input mode of a plurality of different input modes.

2. The input device of claim 1, wherein the plurality of input modes include a first input mode corresponding to motion control input commands and a second input mode corresponding to gesture control input commands.

3. The input device of claim 1, wherein the information relating to a position, orientation, or motion of one or more controllers includes three-dimensional position data.

4. The input device of claim 1, wherein the plurality of input modes include a programmable input mode.

5. The input device of claim 1, wherein the input mode signal is configured to prompt the computer system to display an input mode-specific user interface to the user.

6. The input device of claim 1, wherein the input mode control is a hardware element activated by user manipulation.

7. The input device of claim 6, wherein the hardware element is a digital button.

8. The input device of claim 6, wherein the input mode control is activated in response to a user manipulating the hardware element for a predetermined period of time.

9. The input device of claim 8, wherein the predetermined period of time is greater than 150 milliseconds.

10. The input device of claim 8, wherein the hardware element provides a separate control input command when a manipulation time period threshold is not exceeded.

11. The input device of claim 6, wherein the hardware element is an analog button.

12. The input device of claim 6, wherein the hardware element is a pressure sensitive button.

13. The input device of claim 12, wherein the pressure sensitive button is configured to activate one or more additional modes of input in response to varying pressures applied to the hardware element.

14. The input device of claim 6, wherein the hardware element is a two-state button.

15. The input device of claim 1, wherein the input mode control is further configured to be continuously activated by a user in order to provide input commands corresponding to the particular input mode.

16. The input device of claim 1, wherein an input corresponding to the particular input mode is executed upon the deactivation of the input mode control.

17. The input device of claim 1, wherein the input mode signal is configured to cause the computer program to revert to interpreting the information relating to the position, orientation or motion of the one or more controllers according to a previous mode.

18. The input device of claim 1, wherein the input mode signal is configured to cause the computer program to revert to interpreting the information relating to the position, orientation or motion of the one or more controllers according to a previous mode upon deactivation of the input control.

19. The input device of claim 1, wherein the input control is incorporated into a wearable component device.

20. The input device of claim 19, wherein the input control is a user action interpreted by the wearable component device as an input control activation command.

21. The input device of claim 19, wherein the user action is a physical movement performed by the user.

22. The input device of claim 19, wherein the user action is an auditory signal created by the user.

23. The input device of claim 1, wherein the input control is activated when one or more of the one or more controllers progresses through a sequence of motions recognized by the computer system as an input control activation sequence.

24. The input device of claim 1, wherein the input control is activated when one or more of the one or more controllers is held in a specific position recognized by the computer system as an input control activation sequence.

25. The input device of claim 1, wherein the input control is a on a first controller, and the position of a second controller is communicated to the computer system with respect to the second input channel.

26. The input device of claim 1, wherein the input control is configured to be activated when a user is prompted by the computer system.

27. The input device of claim 1, wherein one or more of the component devices includes a microphone capable of interpreting sounds made by a user and a camera capable of tracking the movement of a user's body for the purpose of motion control input.

28. The input device of claim 27, wherein the user acts as the controller.

29. The input device of claim 28, wherein the input control is activated by a specific sequence of actions performed by the user.

30. A method for providing input to a computer system to interact with a computer, comprising:
communicating information relating to a position, orientation, or motion of one or more controllers from one or more tracking devices to the computer system; and
communicating an input mode signal to the computer system during interaction with the computer program with an input mode control, wherein the input mode signal is configured to cause the computer program to interpret the information relating to the position, orientation or motion of the one or more controllers according to a particular input mode of a plurality of input modes.

31. A computer-readable medium having computer executable instructions embodied therein, the computer executable instructions being configured to cause a computer system to cause an input device to:
communicate information relating to a position, orientation, or motion of one or more controllers from one or more tracking devices to the computer system; and
communicate an input mode signal to the computer system during interaction with the computer program with an input mode control, wherein the input mode signal is configured to cause the computer program to interpret the information relating to the position, orientation or motion of the one or more controllers according to a particular input mode of a plurality of input modes

32. A method for operating a computer system, comprising:
receiving information relating to a position, orientation, or motion of one or more controllers from one or more tracking devices with the computer system;
interpreting the information relating to the position, orientation or motion of the one or more controllers according to a first input mode during interaction between the one or more controllers with a computer program running on the computer system;
receiving an input mode signal from an input control with the computer system during interaction between the one or more controllers with the computer program; and
in response to the input mode signal, causing the computer program to interpret the information relating to the position, orientation or motion of the one or more controllers according to a second input mode that is different from the first input mode.

33. The method of claim 32, wherein the first input mode corresponds to motion control input commands and the second input mode corresponding to gesture control input commands

34. The method of claim 32, wherein the information relating to a position, orientation, or motion of one or more controllers includes three-dimensional position data.

35. The input device of claim 32, wherein the second input mode is a programmable input mode.

36. The method of claim 32, wherein the computer system displays an input mode-specific user interface to the user in response to the input mode signal.

37. The method of claim 36, wherein the input mode-specific user interface is configured to display actions corresponding to the second input mode that are available to a user.

38. The method of claim 32, wherein the first or second input mode provides one-to-one control of a digital avatar.

39. The method of claim 32, wherein the input mode control is continuously activated in order to provide input commands corresponding to the second input mode.

40. The method of claim 32, wherein an input corresponding to the second input mode is executed upon the deactivation of the input mode control.

41. The method of claim 32, further comprising reverting the computer program to interpreting the information relating to the position, orientation or motion of the one or more controllers according to the first input mode in response to receiving a subsequent input mode signal.

42. The method of claim 32, further comprising reverting the computer program to interpreting the information relating to the position, orientation or motion of the one or more controllers according to the first input mode upon deactivation of the input control.

43. A computer system, comprising:
a processor;
a memory;
computer executable instructions embodied in the memory and executable by the processor, wherein the computer executable instructions are configured to cause the computer system to:
receive information relating to a position, orientation, or motion of one or more controllers from one or more tracking devices with the computer system;
interpret the information relating to the position, orientation or motion of the one or more controllers according to a first input mode during interaction between the one or more controllers with a computer program running on the computer system;
receive an input mode signal from an input control with the computer system during interaction between the one or more controllers with the computer program; and
in response to the input mode signal, cause the computer program to interpret the information relating to the position, orientation or motion of the one or more controllers according to a second input mode that is different from the first input mode.

44. A computer-readable medium having computer executable instructions embodied therein, the computer executable instructions being configured to cause a computer system to cause a computer system to:
receive information relating to a position, orientation, or motion of one or more controllers from one or more tracking devices with the computer system;
interpret the information relating to the position, orientation or motion of the one or more controllers according to a first input mode during interaction between the one or more controllers with a computer program running on the computer system;
receive an input mode signal from an input control with the computer system during interaction between the one or more controllers with the computer program; and
in response to the input mode signal, cause the computer program to interpret the information relating to the position, orientation or motion of the one or more controllers according to a second input mode that is different from the first input mode.
